(19) United States
(12) Patent Application Publication
(10) Pub. No.: US 2012/0176540 A1
(43) Pub. Date: Jul. 12, 2012

(54) SYSTEM AND METHOD FOR TRANSCODING LIVE CLOSED CAPTIONS AND SUBTITLES

(75) Inventors: Scott C. Labrozzi, Cary, NC (US); James Christopher Akers, Raleigh, NC (US)

(73) Assignee: Cisco Technology, Inc.

(21) Appl. No.: 13/346,541

(22) Filed: Jan. 9, 2012

Related U.S. Application Data
(60) Provisional application No. 61/431,222, filed on Jan. 10, 2011.

(51) Int. Cl. H04N 7/00

(52) U.S. Cl. 348/468; 348/E07.033

(57) ABSTRACT

A method is provided in one example and includes receiving video data from a video source in a first format, where the video data includes associated text to be overlaid on the video data as part of a video stream. The method also includes generating a plurality of fragments based on the text. The fragments include respective regions having a designated time duration. The method also includes using the plurality of fragments to convert the video data into a second format to be provided as an output, which is based on the video data that was received. In more specific embodiments, the first format is associated with a Paint-On caption or a Roll-Up caption, and the second format is associated with a Pop-On caption. The first format can also be associated with subtitles.

### CROSS-REFERENCE TO RELATED APPLICATIONS

This Application claims the benefit of priority under 35 U.S.C. §119(e) to U.S. Provisional Patent Application Ser. No. 61/431,222 filed on Jan. 10, 2011 and entitled “Transcoding Live Closed Captions and Subtitles,” which is hereby incorporated by reference in its entirety.

### TECHNICAL FIELD

This disclosure relates in general to the field of communications and, more particularly, to a system and a method for transcoding live close captions and subtitles.

### BACKGROUND

For decades, television programs have optionally included closed caption (CC) information. Closed captions are simply rows of text, which can be optionally displayed on a television picture. Two main uses of closed captions are to present a visual representation of the audio track for hearing-impaired viewers and to present a visual representation of the audio track in a different language. Other uses may include entertainment venues (e.g., the opera), recreational environments (e.g., workout facilities in which audio is intentionally muted), sports bars in which ambient noise is high, etc. Since the 1970s, the United States Federal Communications Commission (FCC) has required closed captions to be included with television broadcasts. Closed caption data generally includes text to be displayed, along with other information, such as control codes, that specify the location and/or appearance of the text. Closed caption data can be inserted into a television broadcast in various ways. As new technologies have evolved, new paradigms should be developed to effectively accommodate their operations.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a video transcoding system according to one embodiment of the present disclosure;

FIG. 2 is a simplified block diagram illustrating additional details associated with the video transcoding system;

FIGS. 3A-3E are simplified timelines illustrating closed captioning and subtitling example scenarios;

FIGS. 4-8 are simplified timelines that illustrate closed caption processing according to certain embodiments of the present disclosure;

FIG. 9 is a block diagram of a caption processor according to one embodiment of the present disclosure;

FIGS. 10A-10B are simplified block diagrams illustrating a line generator, an add line processor, and a fragment generator according to certain embodiments of the present disclosure; and

FIGS. 11-14A-B are flowcharts illustrating example caption processing activities associated with the video transcoding system of the present disclosure.

### DETAILED DESCRIPTION OF EXAMPLE EMBODIMENTS

### Overview

A method is provided in one example and includes receiving video data from a video source in a first format, where the video data includes associated text to be overlaid on the video data as part of a video stream. The method also includes generating a plurality of fragments based on the text. The fragments include respective regions having a designated time duration. The method also includes using the plurality of fragments to convert the video data into a second format to be provided as an output, which is based on the video data that was received.

In more specific embodiments, the first format is associated with a Paint-On caption or a Roll-Up caption, and the second format is associated with a Pop-On caption. The first format can also be associated with subtitles. In more detailed instances, a sum of particular time durations of particular regions in a particular fragment of the text is equal to an entire time duration of the particular fragment.

The method may also include evaluating timestamps associated with caption data; and reordering the caption data to match an ordering of video frames for the output. Additionally, the method may include determining a level of space that a video processing module should reserve in a particular video frame associated with the video data. The method may also include providing a target bit rate based on an amount of caption data being processed at a packaging agent that converts the video data between the first format and the second format. In yet other implementations, the method can include correcting errors in caption data that includes the text and control codes. Other example scenarios include communicating information concerning frame ordering and frame timing for the video data.

### Example Embodiments

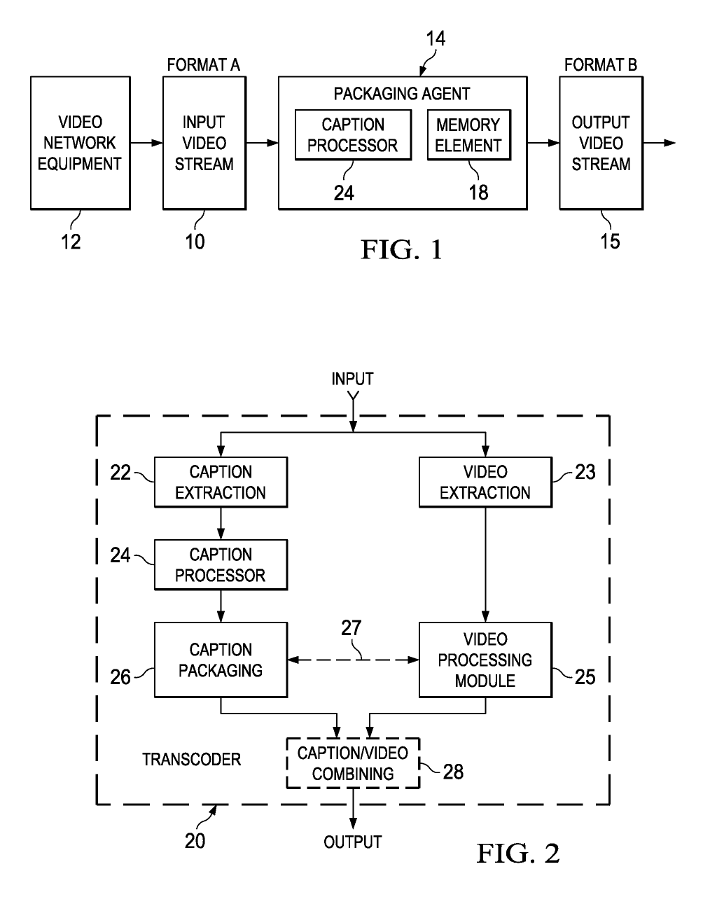

Turning to FIG. 1, FIG. 1 is a simplified block diagram of a video transcoding system according to certain embodiments of the present disclosure. FIG. 1 may include an instance of video network equipment 12, an input video stream 10, a packaging agent 14, and an output video stream 15. Video network equipment 12 may be inclusive of any suitable device or equipment such as a video server, a connection to a network, a digital video recorder (DVR), a broadband link, etc. Packaging agent 14 may include a caption processor 24 and a memory element 18. Packaging agent 14 may be any suitable encapsulation element, multiplexing element, transcoding element, or more generally a processing unit that is configured to process video information.

In operation, packaging agent 14 (which may be a transcoder in an example scenario) is configured to receive input video stream 10 including associated caption data in a first format (Format A). The transcoder processes the input video stream including the associated caption data and, subsequently, generates an output video stream, which has been transcoded into a second video format (Format B). In certain embodiments, the output video stream may include processed caption data that is in a form that is appropriate for the second video format. The video stream and captions generated may not necessarily be combined, but could be delivered separately. In addition, output video stream 15 may reflect a certain optimal timing and/or an enhanced readability associated with the rendered information. Stated in different terminology, the conversion between Format A and Format B may account for the user experience in presenting the data in a consistent form at the appropriate time.

Note that before turning to additional activities associated with the present disclosure, certain foundational information is provided in order to assist the audience in understanding fundamental problems encountered in streaming video that involves subtitles and closed captioning. Previously, CC data was transmitted using a special line of National Television Standards Committee (NTSC) format video (line 21) that is transmitted to televisions, but that is not displayed. At the television transmitter, the closed caption data is converted to intensity pulses in this special video line. The receiving television recognizes the pulses in this special line of video and converts the pulses back into closed caption data. The television then interprets the closed caption data and displays the captions (text) on the picture.

CC data is typically carried in two fields: CC Field 1 and CC Field 2. CC Field 1 carries two interleaved channels, CC1 and CC2, while CC Field 2 carries two additional interleaved channels, CC3 and CC4. Multiple CC channels can be defined such that a program can be encoded, for example, with CC data for multiple languages. To separate the interleaved data into individual data streams, such as CC1 and CC2 data streams, the data bytes are interpreted into control codes and characters as specified in the Consumer Electronics Association (CEA) standard CEA-608-C.

In recent years, there have been a number of technological changes in how television programs are stored and transmitted. The most fundamental change is that digital storage and the transmission of television signals has largely replaced analog storage and transmission. Analog storage (VHS tapes, for example) and analog transmission (over-the-air antenna, for example) have been replaced by digital storage (DVD, for example) and digital transmission (“Digital Cable” and satellite, for example). The digital formats generally do not include the special line of video that analog broadcasts use to transmit closed caption data.

The MPEG2 compression format, which until recently was used by essentially all digital broadcasts for transmitting video, allows for optionally including digital closed caption data as user data with every frame. Other digital formats include serial digital interface (SDI), which is an uncompressed digital signal transmitted at 270 Mb/sec, and which is typically used for connecting video equipment within a video processing facility, for example a television studio. Asynchronous serial interface (ASI) is a compressed digital signal that operates at 270 Mb/sec and contains one or more compressed video streams.

In the mid-1990s, a new closed caption format referred to as DTVCC (Digital Television Closed Captions) was created, and it is defined by the standard CEA-708-B. DTVCC takes advantage of the additional capacity available in digital transmissions, which allows roughly ten times as much caption data to be transmitted in comparison to CC data. As a result, DTVCC can be used to display similar and more elaborate captions than CC. DTVCC data is organized into 63 channels or “services,” which are generally interleaved together. To separate the data into constituent channels (or services), the DTVCC data is interpreted according to the standard CEA-708-B. As the FCC continues to require broadcasters to transition to digital television (DTV) broadcasts, more programs are being created that include DTVCC captions.

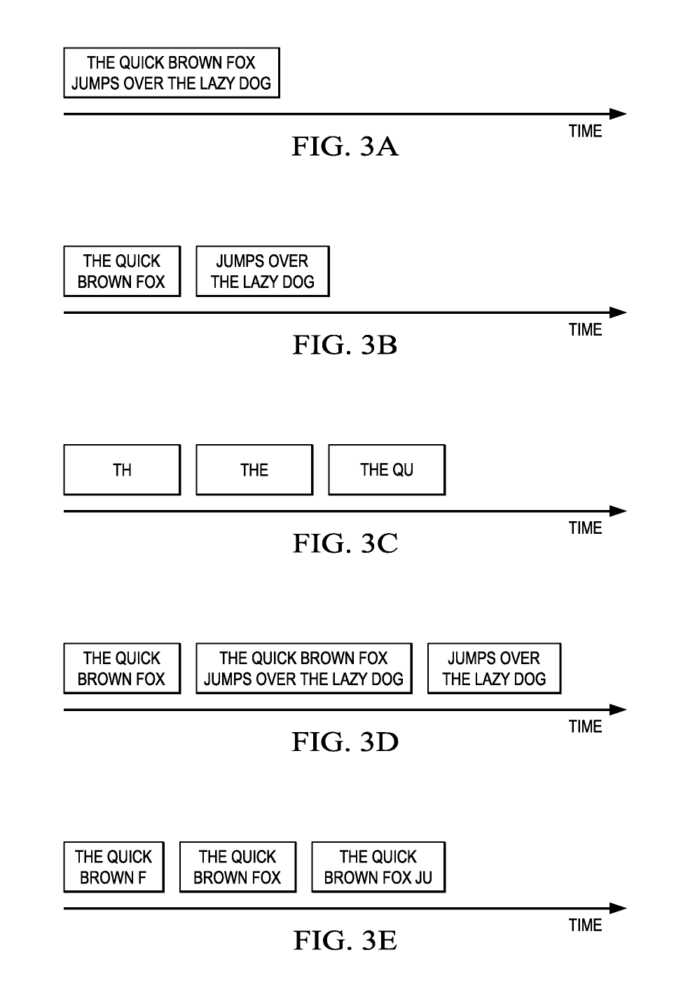

Turning to FIGS. 3A-3E, FIGS. 3A-3E are simplified timelines illustrating close captioning and subtitling example scenarios associated with the present disclosure. Subtitling and closed captioning text are authored using three methods or formats, which control the flow of text onto the display area to maximize readability and viewer comprehension. These formats are Paint-On, Pop-On, and Roll-Up. In these cases, it is desired to have the text displayed as close in time to the spoken, audible version. To illustrate these forms, assume the text “The quick brown fox jumps over the lazy dog” was to be displayed.

In the case of Pop-On processing, the text is displayed at one time, as illustrated in FIG. 3A. The same text could have been popped on in two chunks, as illustrated in FIG. 3B. Pop-On formatting is often found in pre-authored content, where the text to be displayed is known in advance. The authoring process occurs after the video content to be captioned has been created. Because the text is known in advance of the authoring process, the captioning can be generated in such a way that it aligns in time exactly with the audio.

For the case of Paint-On formatting, Paint-On text is typically displayed a few characters at a time. This gives the effect of text slowly being painted to the display. FIG. 3C illustrates an example where two characters (including spaces) are displayed at a time. Paint-On formatting is often found in live content where the text to be displayed is not known in advance. In such situations, a stenocaptioner transcribes the audio in real time to text. Because a stenocaptioner is listening to the live audio feed and transcribing it in real time, there is often a delay between the source audio and the authored captions.

In the case of Roll-Up processing, lines of text are rolled up and new lines of text or characters are then either popped-on or painted-on below it. In the example illustrated in FIG. 3D, a single line of text is displayed initially. A second line of text is later displayed in the same position as the first line and the first line rolls up a line. Finally, in the example shown in FIG. 3D, the second line of text also rolls up and the first line of text is removed. In the example shown in FIG. 3E, text is being painted-on as well as rolled-up. After the first line of text is completely painted-on, it rolls-up with the addition of new text being painted-on below it.

Subtitling and closed captioning are similar features of video in that both processes cause text to be rendered onto a video program (i.e., overlaid over video data). However, there are some important differences. For example, subtitling is generally carried in a teletext field, while closed caption data is carried in a closed caption field, as described above. In a generic sense, subtitling may simply be considered another way of delivering captions: both for the hearing impaired and for multilanguage support. Commonly, subtitling has a higher bandwidth than captions such that more data can be sent via subtitles. In Europe, having multilanguage subtitles is important because of the larger diversity of languages.

Unlike closed captioning, in which text is transmitted a few characters at a time, subtitling can be encoded as a growing string of text. As an example, the phrase “The quick brown fox jumps over the lazy dog” can be provided in subtitles as a growing string of text, for example as “The quick”, “The quick brown fox jumps”, “The quick brown fox jumps over the lazy,” etc. Thus, in subtitling, the same text string can be provided multiple times. The differences between subtitling and closed captioning can present difficulties in a transcoding system that processes and/or formats text for video signals.

Turning to FIG. 2, FIG. 2 is a simplified block diagram illustrating example details associated with the present disclosure. The architecture of FIG. 2 includes a transcoder 20, which includes a caption extraction 22, caption processor 24, a caption packaging 26, an optional communication path 27, a video processing module 25, a video extraction 23, and an instance of caption/video combining 28. The input video stream can be provided to both caption extraction 22 and video extraction 23. Caption extraction 22 is configured to extract the caption data from the input video stream. As noted above, the caption data may be stored in the input video stream in a number of different formats including CC, DTVCC, SAMI, Subtitle, and/or Teletext.

Additionally, caption extraction 22 may also parse the input video stream to determine ordering of the input data frames so that the caption data can be reordered into presentation order. Furthermore, caption extraction 22 can assign timestamps to the caption data to facilitate later reordering and combination of the processed caption data with the transcoded video frames. Video extraction 23 extracts the video frames and may reorder the video frames in preparation for processing. When the video frames are reordered, video extraction 23 may also perform rendering to generate video frames for processing from coded video data.

In operation, the extracted captions are processed by caption processor 24. Caption processor 24 may be configured to translate the caption data from one format to another. For example, caption processor 24 may be configured to convert Paint-On or Roll-Up captions to Pop-On captions in some embodiments, as described in more detail below. Caption processor 24 may also correct errors in the caption data (including errors in text and/or control codes).

Caption packaging 26 constructs the caption data packet that is to be inserted into the output video stream. The output can be formatted as compressed digital bitstream user data, SDI ancillary data, vertical blanking interval (VBI), etc. A number of parameters, such as output frame rate, IVT flags, interlace vs. progressive scanning, etc., may affect these operations. Caption packaging 26 can combine CC and DTVCC data produced by caption processor 24 into a form that is required for combining with video and/or writing directly to the output.

Video processing module 25 is configured to perform transcoding of the input video stream (excluding the caption data) from the first video format to the second video format. For example, video processing module 25 can transcode the input video stream from a format, such as SDI, ASI, MPEG2, VC-1, H.264, NTSC, or PAL, to another format. Video processing module 25 may reorder the output video frames into encoded order. Video processing module 25 may transcode the video to the same format, but change other parameters such as bit rate, image size, etc.

Caption/video combining 28 is configured to insert the packaged caption data into appropriate locations in the transcoded video stream output by video processing module 25. In order to accomplish this, caption/video combining 28 may examine timestamps associated with the caption data and may reorder the caption data to match the ordering of the frames output by video processing module 25. Caption/video combining 28 may also parse the output video stream provided by video processing module 25 to determine the coded order of frames, which may be based on a particular coding scheme used by video processing module 25. Caption/video combining 28 may output caption data of multiple formats to multiple destinations, for example, CC and DTVCC may be output to the same file as the video, and SAMI may be written to a separate file. Similarly, CC and DTVCC may be written to both the video file and to a separate file.

In some embodiments, video processing module 25 may reserve space in the output video stream for caption data. However, doing so may unnecessarily reduce video quality because some video frames may not have any associated caption data. Accordingly, in some embodiments, caption packaging 26 and video processing module 25 may communicate via optional communication path 27 to address this issue. For example, caption packaging 26 can transmit information to video processing module 25 concerning how much space the video processing module needs to reserve in a particular frame (which can be identified by frame number and/or timestamp). Likewise, video processing module 25 can transmit information to caption packaging 26 via communication path 27 concerning the frame ordering and/or frame timing. Frame timing may be particularly important in cases where the output video stream is encoded with a different frame rate than the input video stream (e.g., 24 fps vs. 30 fps). Knowledge of the frame timing can assist caption packaging 26 in synchronizing the caption data with the output video frames.

In some embodiments, caption packaging 26 can provide a target bit rate to video processing module 25 based on the amount of caption data processed by caption packaging 26. For example, caption packaging 26 may instruct the video processing module to encode the video at a lower bit rate to avoid potential bandwidth/timing problems when the video stream (including caption data) is decoded by a subsequent receiver. Video processing module 25 may then encode the video stream at the target bit rate provided by caption packaging 26. Then, when the caption data is combined with the video data, the total bandwidth occupied by the output video stream may not exceed a maximum allowable bandwidth. One drawback to this approach is that the actual bit rate of the output video stream may be different from the encoded bit rate written into the video stream by video processing module 25, which may cause difficulty for a downstream multiplexer. Stated differently, the bit rate used by the encoder is stored in the encoded video stream. However, the actual bit rate of the stream (after the caption data is inserted) may be greater than the encoded bit rate. The actual bit rate may, therefore, be different from the encoded bit rate that is expected by a downstream video processing module such as a multiplexer.

Many modern digital video streaming formats either do not define a mechanism for delivering source captioning/subtitles or the mechanisms that do exist do not handle Paint-On and/or Roll-Up processing formats. In some cases, formats may utilize a mechanism such as the Timed Text Markup Language (TTML) defined by the W3C Organization, which itself defines a grammar that allows for the implementation of these three methods, while the implementation handling the display does not. For these reasons, Paint-On and Roll-Up formats should be converted to a Pop-On form.

In a video on demand (VOD) or post-processing environment, a captioning/subtitling processor may have the advantage of knowing the flow of conversations in the video program (i.e., what will be said by whom and when). In this scenario, it is a simple task to reduce the styles to text, group text into Pop-On blocks, and author the content using a Pop-On style. In contrast, in a live processing environment, a captioning/subtitling processor, such as caption processor 24, does not have the knowledge or foresight of the flow of textual conversation will be ahead of time. If such a processor tried to buffer the flow to gain some knowledge, it may dramatically impact the delay of delivering text, and thus negatively impact the overall synchronization of text-to-audio in the video program.

Certain technologies simply decode closed captions and subtitles to text strings without regard to how and when the text is finally rendered to a display. In contrast, some embodiments of the present disclosure combine the creation of text strings from source captions/subtitles with control of how the textual data is displayed: including both presentation layout and timing. Embodiments of the present disclosure may have the advantage of supporting display rendering mechanisms that do not themselves support the Paint-On and Roll-Up styles, and may do so while increasing readability and/or viewer comprehension, as well as potentially reducing delay. Thus, embodiments of the present disclosure may be able to take source captions/subtitles authored to be rendered via Paint-On and/or Roll-Up styles, and effectively convert these to a rendering form that supports the Pop-On style.

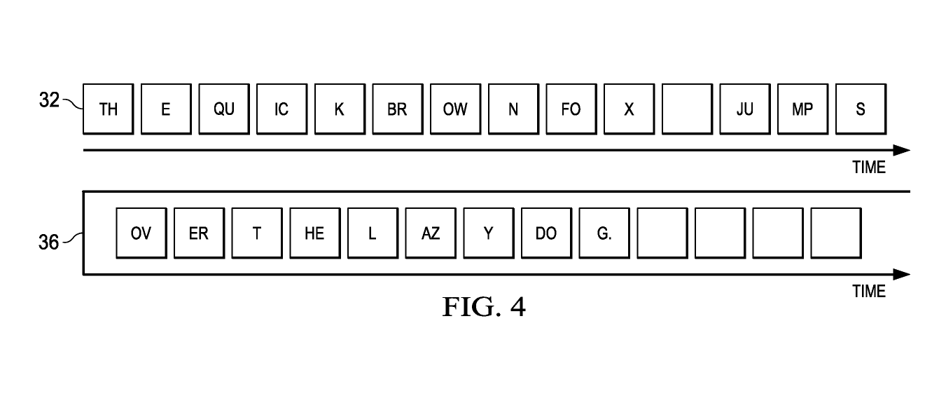

Turning to FIG. 4, FIG. 4 is a simplified timeline associated with the present disclosure. In the context of a flow to discrete lines, consider again the example of: “The quick brown fox jumps over the lazy dog.” Applying a Paint-On style utilizing standard EIA-608 Closed Captioning, which is limited to generating a pair of characters per-video frame, could result in a Paint-On/Roll-Up flow as shown in FIG. 4, which illustrates a plurality of frames 32 and 36 provided sequentially in time along a timeline.

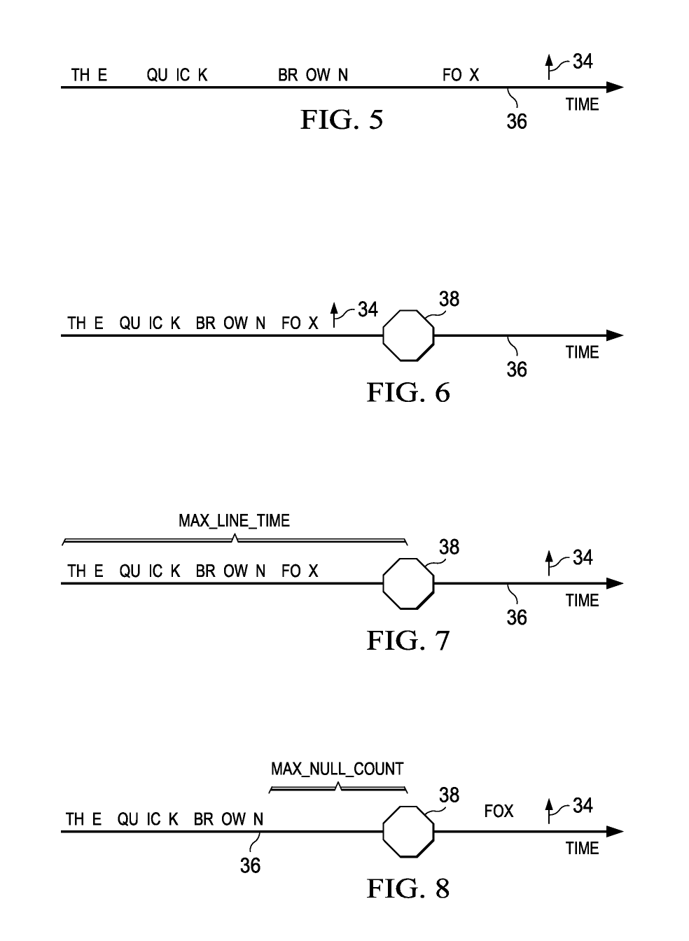

With a Paint-On style, it is expected that as the characters authored into the stream arrive at the display device, they are painted onto the video frames. In a conversion to a Pop-On style, a block of text should be displayed all at once. Caption processor 24 should make a decision on when to produce this block of text. While caption processor 24 could wait until a line is complete, it may not know when the line is complete for a significant period of time. In the above example, the Roll-Up command can be used as an indicator that the previous line is complete; however, no such command follows the final characters (“g.”). Additionally, while the Roll-Up command could be used, it should be noted that the original authoring of the text expected a Paint-On approach and not one that relied on the Roll-Up command for text to be rendered. As such, the time from the start of the text above (Th) to the Roll-up command could be significant, and waiting for such a signal may introduce further delay on displaying text meant to be painted onto the display as it arrived, as illustrated in FIG. 5. In FIG. 5, an up arrow 34 represents a command to Roll-Up the previous line of text to the next line up.

For captioning, some embodiments use controls, such as Paint-On update and Roll-Up commands, to generate discrete lines. In addition, some embodiments use timing controls that look both at the time since characters started to be generated to the current time, and the time between characters. In some embodiments, a line is generated if any of the following conditions is met:

1) If a naturally occurring in-stream command, such as a Roll-Up command, indicates a line change, as shown in FIG. 6.

2) If Max_Line_Time amount of time has passed since the initial character in the line was received, as shown in FIG. 7. In FIG. 7, a symbol 38 indicates that a line is generated at that point, for example, even though no Roll-Up command has been received.

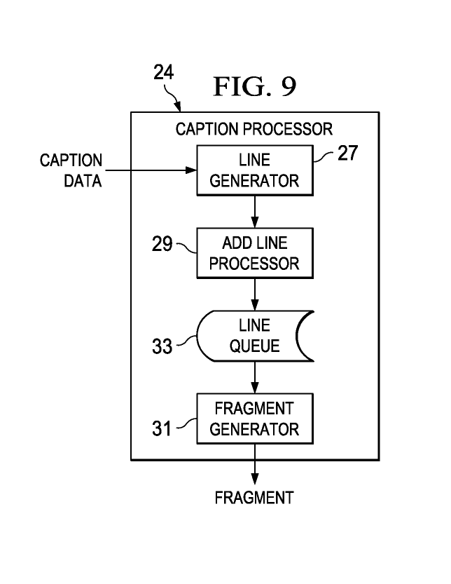

3) If Max Null Count null characters have been received since the last valid character was received, as shown in FIG. 8.

For subtitles, lines that have words in them are received in packets. Each subsequent packet could add new words to the current line, move the current line up, or start a new line. The lines and words can be stored until it is determined that the line or lines is/are complete and ready to be delivered. The following represents a short example:

| Time | Line | Text | Note |
|---|---|---|---|
| 1 | 18 | The quick brown | |
| 2 | 18 | The quick brown fox | |
| 3 | 16 | The quick brown fox | ***At this time, the text from |
| | | | time 2 is delivered |
| | 18 | Jumps | |
| 4 | 16 | The quick brown fox | |
| | 18 | Jumps over the lazy | |
| 5 | 16 | Jumps over the lazy | ***At this time, the text from |
| | | | time 4 is delivered |
| | 18 | dog | |

If after a certain period of time (e.g., time period Max_Null_Count shown in FIG. 8), there are no new updates or the text has not changed (i.e., only null characters have been received), the current text would then be delivered.

FIG. 9 is a simplified block diagram illustrating details associated with caption processor 24. As shown in FIG. 9, caption processor 24 may include a line generator 27, an add line processor 29, a fragment generator 31, and a line queue 33. The fragments to be generated can be viewed as containers having regions within them, where the regions have varying durations. Hence, multiple regions can be packed into a fixed container. Line generator 27 receives caption data, such as closed caption data and/or subtitle data, and generates lines containing the caption data. The lines generated by line generator 27 are passed to add line processor 29, which determines which lines to add to line queue 33 and when to add them. Fragment generator 31 generates fragments, which are documents that contain one or more lines for display for a defined period of time. The fragments are used by caption packaging 26 to generate packaged caption data for insertion into the video signal by transcoder 20. Operations of line generator 27, add line processor 29, and fragment generator 31 are described in more detail below.

Turning to the infrastructure of the present disclosure, packaging agent 14 is a processing element that can exchange and process video data, for example, between two locations or devices (e.g., an input content source and an output video destination). Packaging agent 14 may be provisioned in a cable television headend (e.g., a master facility for receiving television signals for processing and distribution over a cable television system), a gateway (i.e., for telecommunications), a single master antenna television headend, (SMATV) (e.g., used for hotels, motels, and commercial properties), personal computers (PCs), set-top boxes (STBs), personal digital assistants (PDAs), voice over Internet protocol (VoIP) phones, Internet connected televisions, cellular telephones, smartphones, consoles, proprietary endpoints, laptops or electronic notebooks, iPhones, iPads, Google Droids, any other type of smartphone, or any other device, component, element, or object capable of initiating data exchanges within the architectures of the present disclosure.

More generally, and as used herein in this Specification, the term ‘packaging agent’ is meant to encompass any of the aforementioned elements, as well as transcoders, multiplexers, encapsulators, modules, processors, etc., where any such packaging agent may be provisioned in a given DVR, router, switch, cable box, bridge, inline service nodes, proxy, video server, processor, module, or any other suitable device, component, element, proprietary appliance, or object operable to exchange information in a video environment. These packaging agents may include any suitable hardware, software, components, modules, interfaces, or objects that facilitate the operations thereof. This may be inclusive of appropriate algorithms and communication protocols that allow for the effective exchange of data or information.

In one implementation, packaging agent 14 includes software to achieve (or to foster) the video transcoding activities discussed herein. This could include the implementation of instances of caption processor 24, video processing module 25, and/or line generator 27. Additionally, each of these packaging agents can have an internal structure (e.g., a processor, a memory element, etc.) to facilitate some of the operations described herein. In other embodiments, these transcoding activities may be executed externally to these packaging agents, or included in some other processing element to achieve the intended functionality. Alternatively, packaging agent 14 and/or processing entities may include software (or reciprocating software) that can coordinate with other devices and elements in order to achieve the transcoding activities described herein. In still other embodiments, one or several devices may include any suitable algorithms, hardware, software, components, modules, interfaces, or objects that facilitate the operations thereof.

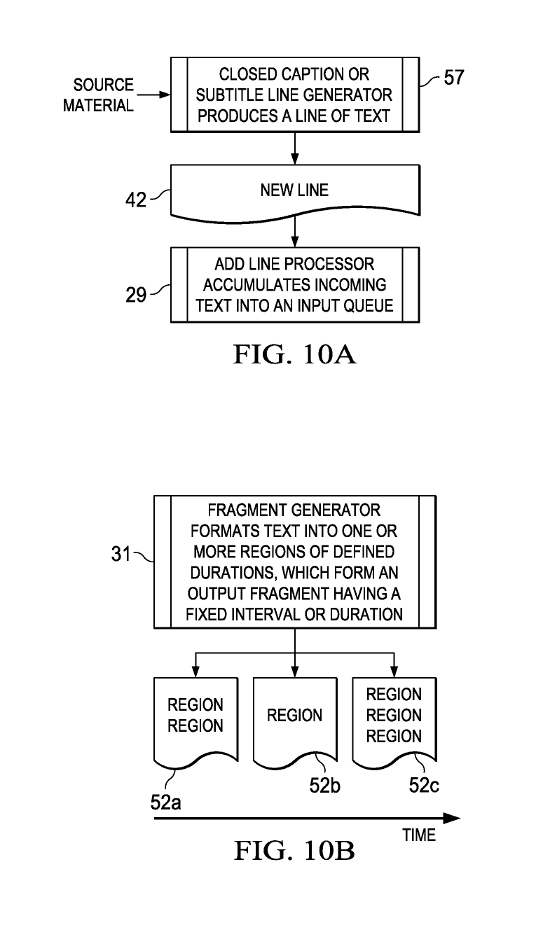

Turning to FIGS. 10A-10B, FIGS. 10A-10B illustrate line generator 27, add line processor 29, and fragment generator 31 in more detail. Referring to FIG. 10A, the line generator is configured to receive video data (e.g., source material that includes text such as closed caption data and/or subtitle text), and produces a new line 42 (of text), which is supplied to add line processor 29. Add line processor 29 is configured to accumulate incoming lines into an input line queue. Referring to FIG. 10B, fragment generator 31 formats text into fragments 52a, 53b, 52c: each of which has a fixed duration. Each fragment can include one or more regions, which may have a duration equal to or shorter than the fragment duration. The sum of the durations of the regions in a fragment can equal the duration of the fragment.

It can be understood that a line may span more than one region and/or more than one fragment. The fragment/region construct described herein may enable better control over the timing and duration of the display of lines on the video screen. Accordingly, fragment generator 31 can produce a single document (e.g., a fragment), representing a fixed amount of time. For example, there could be a fragment generated every two seconds in certain embodiments of the present disclosure. Within a fragment, there can be multiple regions, where the user can define the maximum number of regions. The first region can start at time 0 within a fragment and the duration of the last region of a fragment can be set such that it ends at the fragment end time. Each region simply represents a period of time within a fragment.

If a fragment's duration is two seconds and there is only one region within the fragment, then this region can start at time 0 and have a 2-second duration ending at time 2. If there are multiple regions within a fragment, they would abut one another in time. For example, in a 2-second fragment with two regions, the first region can start at time 0. If the first region has a 1.5 second duration, then the second region would start at time 1.5 seconds and end at time two seconds, thus having a 0.5 second duration.

A region may be defined to have a maximum number of lines (“Max_Lines_In_Region”). The user can define this value. Given N lines, fragment generator 31 has the ability to simulate Roll-Up formatting using Pop-On formatting. The maximum number of lines Max_Lines_In_Region is typically set to one for subtitling, and is typically two or three for closed captioning. The fragment generator may also define a target duration per-line (“Target_Line_Duration”). The higher the Max_Lines_In_Region count, the longer the Target_Line_Duration can be set to, as the system can use Max_Lines_In_Region for simulated Roll-Up, and thus discrete lines can be displayed for a longer time because others can flow under it.

Fragment generator 31 can operate on an input queue of lines. For subtitling, an input line could have a line break in it, and thus could represent multiple lines on the screen. Fragment generator 31 may further define a speed ‘S’ at which the target duration Target_Line_Duration is modified. As the input queue fills up, the speed S may be increased (thereby decreasing the Target_Line_Duration), for the purposes of reducing delay. Because some streaming formats segment text into fragments of fixed time, fragment generator 31 generates fragments of fixed duration Fragment_Duration into which discrete lines of Text are laid out, with each line given a start time and an end time in the fragment based on the line's target duration. This allows lines of text to span multiple fragments.

Since subtitling can produce growing textual strings, such as: “The quick”, “The quick brown”, “The quick brown fox”, etc., fragment generator 31 may concatenate textual information only in the event that previous information has not yet been delivered in a previous fragment. For subtitles, fragment generator 31 can keep track of the persistence of lines. Unlike captions, subtitles can produce the same text information multiple times. To keep previously-displayed text from being removed from the display, only to be redisplayed later, a line can be marked as being persistent, which would not be cleared until an explicit clear command is found in the source. If new text arrives that is identical to previously displayed text that is persistent, the new text may simply be discarded.

During fragment generation, fragment generator 31 keeps track of how many lines to remove (Lines_to_Delete), and after the fragment is complete, that number of lines is removed from the queue: except that the last line is not removed from the queue if persistence is desired. “Persistence” in this context means that the last line is kept on the display until a new line comes in (e.g., regardless of how long it has been displayed). Note that the new line may be empty, which is one way that persistent lines may be cleared.

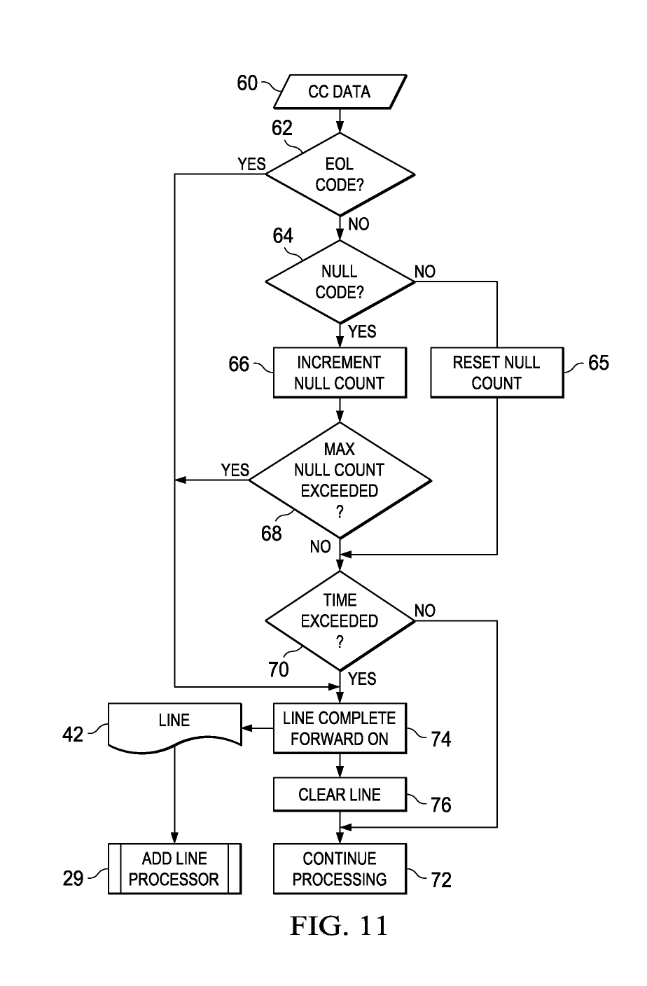

FIG. 11 is a simplified flowchart illustrating certain caption processing associated with the present disclosure. As shown therein, closed caption data 60 (“CC data”) is received by line generator 27. CC data 60 is first analyzed to determine if it includes an end of line (EOL) code (illustrated in Block 62). If so, the line generator is configured to determine that the line is complete, and the flow proceeds to Block 74. Otherwise, operations proceed to Block 64, at which the line generator determines if CC data 60 includes a null code, indicating that CC data 60 does not contain any valid display or control characters. If CC data 60 includes null characters, a null character count is incremented (illustrated in Block 66), and operations proceed to Block 68 to determine if a null count has exceeded a maximum allowable number of null codes. If so, line generator 27 determines that the line is complete, and the flow proceeds to Block 74.

If in Block 64 it is determined that CC data 60 does not contain a null code, the null count is reset (illustrated in Block 65), and operations proceed to Block 70. Similarly, if it is determined at Block 68 that the null count has not been exceeded, operations proceed to Block 70. It should be noted that the maximum allowable number of null codes corresponds to the value Max_Null_Count (illustrated in FIG. 8 as the maximum amount of time that can passed since the last valid character was received before the line generator will determine that the line is complete).

Referring again to FIG. 11, at Block 70 line generator 27 determines if a maximum amount of time has been exceeded since the first character in the line was received (corresponding to the value Max_Line_Time illustrated in FIG. 7). If not, operations proceed to Block 72 for the line generator to continue processing CC data 60.

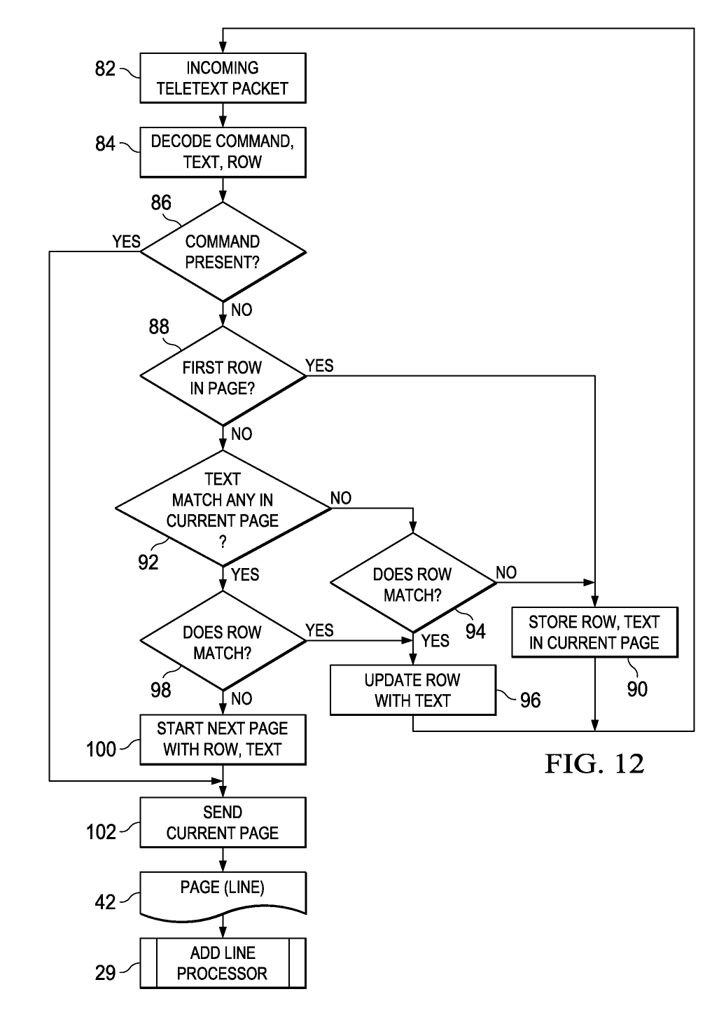

If the maximum amount of time Max_Line_Time since the first character in the line was received has been exceeded, line generator 27 determines that the line is complete, and operations proceed to Block 74. At Block 74, line generator 27 generates a line and passes the line to add line processor 29. Operations then proceed to Block 76, in which line generator 27 clears the current line, and then the flow proceeds to Block 72 to continue processing. Additional operations of line generator 27 for processing subtitle data are illustrated in FIG. 12. As shown therein, an incoming teletext packet containing subtitle data is received (illustrated in Block 82). The teletext packet is decoded at Block 84 to determine if it contains a command, text and/or row information.

If a command is detected in the packet (illustrated in Block 86), operations proceed to Block 102 and the current page of teletext data is output as line 42 to the add line processor. Otherwise, line generator 27 determines if the decoded text corresponds to the first row in a page (illustrated in Block 88). If so, the row and text decoded from the packet are stored in the current page (illustrated in Block 90), and operations return to Block 82. If the text does not correspond to the first row in a page, line generator 27 determines if the text matches any text in the current page (illustrated in Block 92). If not, the line generator determines if the row of the text matches the current row (illustrated in Block 94). If not, the row and text are stored in the current page (illustrated in Block 90). However, if the row does match, the row is updated with the new text (illustrated in Block 96).

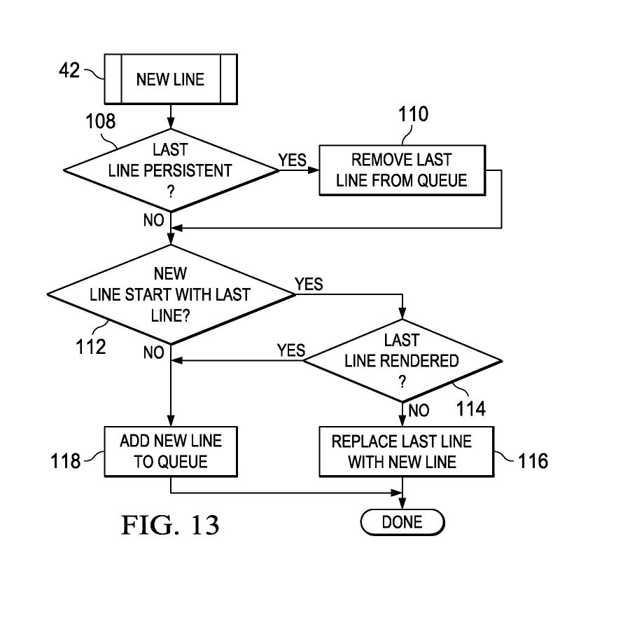

If in Block 92 it is determined that the text does match text in the current page, the line generator determines if the rows match (illustrated in Block 98). If so, the row is updated with the new text (illustrated in Block 96). Otherwise, a new page is started with the new row and text information (illustrated in Block 100), and the current page is sent (illustrated in Block 102). Additional operations of add line processor 29 are illustrated in FIG. 13. As noted above, add line processor 29 receives completed lines from line generator 27. Add line processor 29 first determines if the previous line is marked as being persistent, as discussed above (illustrated in Block 108). If so, the previous line is removed from the line queue (illustrated in Block 110). If not, the add line processor determines if the new line starts with the previous line (illustrated in Block 112). For example, if the previous line was “The quick brown” and the new line was “The quick brown fox”, the add line processor would determine that the new line starts with the previous line.

However, if the new line does start with the previous line, the add line processor determines if the previous line has been rendered already (illustrated in Block 114). If not, the previous line is replaced in the queue with the new line (illustrated in Block 116). However, if the previous line has already been rendered, the new line is added to the line queue (illustrated in Block 118). If not, the new line is added to the line queue (illustrated in Block 118).

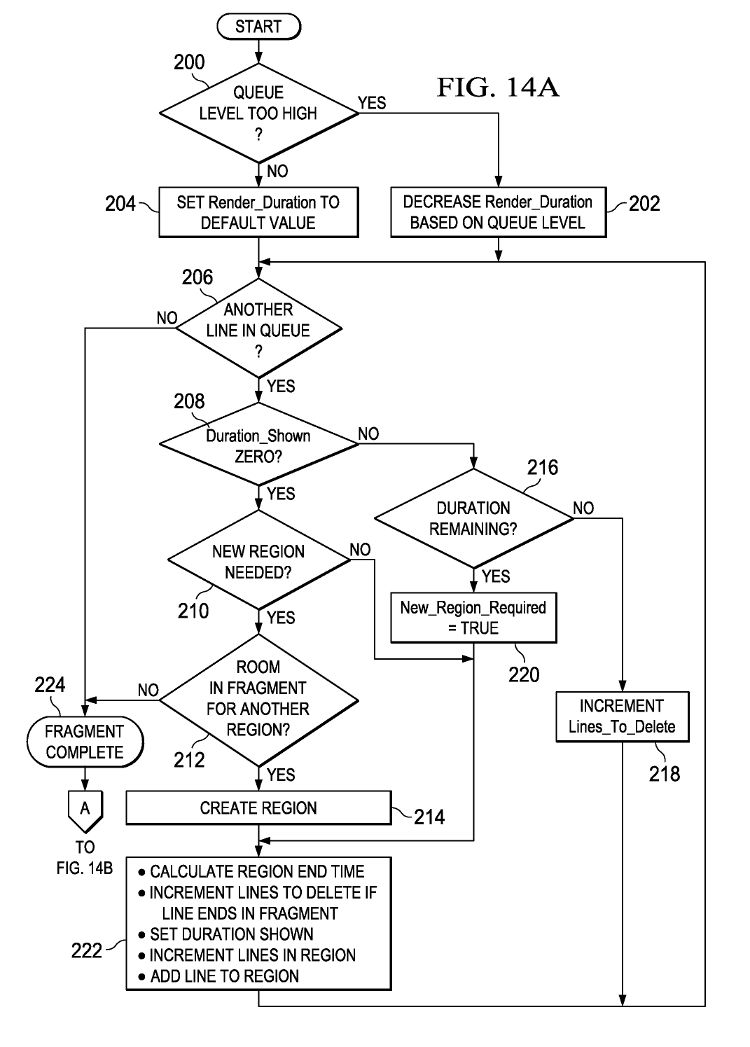

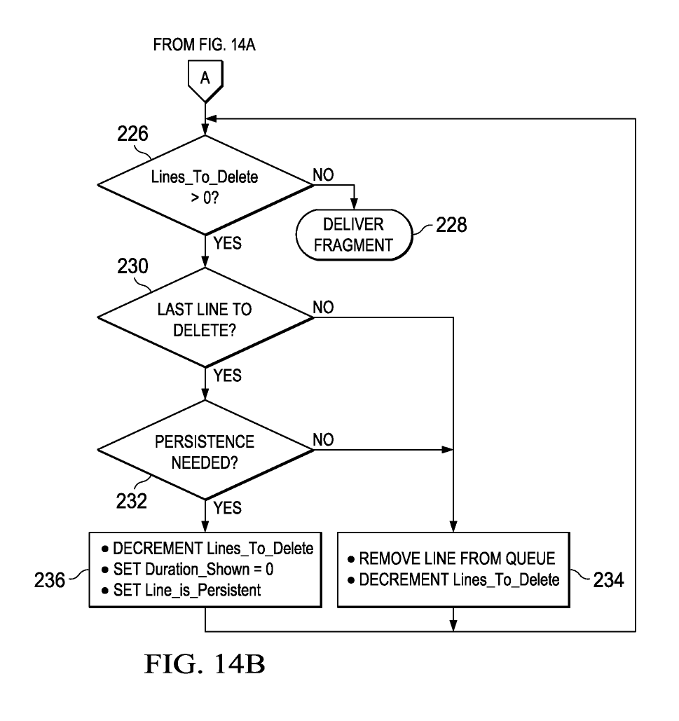

FIGS. 14A-14B are simplified flowcharts illustrating certain operations of fragment generator 31. The fragment generator periodically checks the input line queue and builds fragments for rendering in the video stream based on the contents of the input line queue. Fragment generator 31 may operate asynchronously from line generator 27 and add line processor 29. As illustrated in FIG. 14A, as a first step in building a fragment, fragment generator 31 may check the level of the input line queue (illustrated in Block 200). If the queue level is too high (e.g., above a predetermined threshold), the Render_Duration value, which sets the target duration for lines to be rendered, is decreased (illustrated in Block 202). Otherwise, the Render_Duration value is set to a default value (illustrated in Block 204).

Fragment generator 31 then checks to see if there is another line in the queue (illustrated in Block 206). If not, the current fragment is deemed to be complete (illustrated in Block 224). If there is a line in the queue, the fragment generator checks the value of the Duration_Shown parameter for the line, which tracks how long the line has been shown (illustrated in Block 208). If the duration shown is non-zero, operations proceed to Block 216 where the fragment generator determines if the line has any duration remaining, and the duration remaining (Duration_Remaining) can be determined according to the following equation:

Duration_Remaining=Render_Duration−Duration_Shown (1)

If the line has no duration remaining, fragment generator 31 increments the count of Lines_to Delete (illustrated in Block 218) and operations proceed to Block 224.

If at Block 216 it is determined that the line does have some duration remaining, the fragment generator determines that a new region is needed (illustrated in Block 220) and sets a parameter New_Region_Required equal to TRUE. Operations then proceed to Block 222, where fragment generator 31 calculates an end time for the next region, increments the Lines_To_Delete parameter if the line ends in the current fragment, sets the value of Duration_Shown, increments the count of a parameter of Lines_in_Region (which tracks the number of lines in the current region) and adds the current line to the region.

The Region_End time is set as the fragment duration if the line is marked as being persistent or if the Region_Start time plus the Duration_Remaining is greater than the fragment duration. Otherwise, the Region_End time is set as the Region_Start time plus the Duration_Remaining. The value of Duration_Shown is incremented by a value equal to the difference between the Region_End time and the Region_Start time. Operations then return to Block 206 where the fragment generator evaluates if there is another line in the input queue.

If in Block 208 it is determined that the value of Duration_Shown for the current line is zero, the fragment generator next determines if a new region is needed (illustrated in Block 210). A new region is needed if New_Region_Required is TRUE (e.g., as set in Block 220), or if the number of lines in the current region is equal to the Max_Lines In_Region parameter described above. If no new region is required, operations proceed to Block 222. However, if it is determined that a new region is needed, fragment generator 31 determines if there is room in the current fragment for another region (illustrated in Block 212). In particular, the fragment generator compares the end time of the current region to the duration of the fragment. If the current region ends before the end of the current fragment, there is room in the current fragment for a new region. Otherwise, the fragment is deemed complete, and operations proceed to Block 224.

If it is determined in Block 212 that there is room in the current fragment for another region, a new region is created (illustrated in Block 214). The starting time of the new region is set as the end time of the previous region. The number of lines in the new region is initially set at zero, and the New_Region_Required flag is set to FALSE. Operations then proceed to Block 222, as noted above. Once it has been determined that the fragment is complete (illustrated in Block 224), the fragment generator checks to see if there are any lines to delete (Lines_To Delete>0) (illustrated in Block 226). If not, the fragment generator delivers the fragment to caption packaging 26 for rendering (illustrated in Block 228).

If there are lines to delete, fragment generator 31 determines if this is the last line in the queue to be deleted (illustrated in Block 230). If not, the fragment generator removes the line from the queue and decrements the Lines_To_Delete count (illustrated in Block 234), and operations return to Block 226. If the fragment generator determines that this is the last line in the queue to be deleted, the fragment generator then determines if persistence is needed (illustrated in Block 232). If persistence is not needed, operations proceed to Block 234. Otherwise, the fragment generator decrements the count of Lines_to_Delete, sets the Duration_Shown to zero, and sets a Line_Is_Persistent flag for the last line in the queue. Operations then return to Block 226.

Note that in terms of the infrastructure of the present disclosure, any number of networks can be used to deliver a video stream to the architecture. The term ‘video data’, as used herein, includes any type of packet exchange, which may be related to any type of video, audio-visual, voice, media, script data, or any type of source or object code, or any other suitable information in any appropriate format that may be communicated from one point to another in the network. This can include routine network communications, unicast communications, point-to-point communications, multicast communications, any type of streaming content, or any other suitable network communication in which an error may be discovered.

Moreover, the network infrastructure can offer a communicative interface between video content sources, endpoint devices, and/or hosts, and may be any local area network (LAN), wireless local area network (WLAN), metropolitan area network (MAN), Intranet, Extranet, WAN, virtual private network (VPN), or any other appropriate architecture or system that facilitates communications in a network environment. Such networks may implement a UDP/IP connection and use a TCP/IP communication language protocol in particular embodiments of the present disclosure. Further, such networks may implement any other suitable communication protocol for transmitting and receiving data packets within the architecture. Data, as used herein in this document, refers to any type of numeric, voice, video, media, or script data, or any type of source or object code, or any other suitable information in any appropriate format that may be communicated from one point to another.

Note that in certain example implementations, the transcoding functions outlined herein may be implemented in logic encoded in one or more non-transitory media (e.g., embedded logic provided in an application specific integrated circuit [ASIC], digital signal processor [DSP] instructions, software [potentially inclusive of object code and source code] to be executed by a processor, or other similar machine, etc.). In some of these instances, a memory element [as shown in FIG. 1] can store data used for the operations described herein. This includes the memory element being able to store code (e.g., software, logic, processor instructions, etc.) that can be executed to carry out the activities described in this Specification. A processor can execute any type of instructions associated with the data to achieve the operations detailed herein in this Specification. In one example, the processor [as shown in FIGS. 1, 2, 9, etc.] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Note that with the example provided above, as well as numerous other examples provided herein, interaction may be described in terms of two, three, or four devices, systems, subsystems, or elements. However, this has been done for purposes of clarity and example only. In certain cases, it may be easier to describe one or more of the functionalities of a given set of flows by only referencing a limited number of video elements. It should be appreciated that the architectures discussed herein (and their teachings) are readily scalable and can accommodate a large number of components, as well as more complicated/sophisticated arrangements and configurations. Accordingly, the examples provided should not limit the scope or inhibit the broad teachings of the architectures discussed herein as potentially applied to a myriad of other architectures.

It is also important to note that the steps in the preceding flow diagrams illustrate only some of the possible signaling scenarios and patterns that may be executed by, or within, the architectures discussed herein. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the architectures discussed herein in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain video components and certain protocols, the architectures discussed herein may be applicable to other protocols and arrangements. Moreover, the present disclosure is equally applicable to various technologies, as these have only been offered for purposes of discussion. Along similar lines, the architectures discussed herein can be extended to any communications involving network elements, where the present disclosure is explicitly not confined to unicasting and multicasting activities.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving video data from a video source in a first format, wherein the video data includes associated text to be overlaid on the video data as part of a video stream;
generating a plurality of fragments based on the text, wherein the fragments include respective regions having a designated time duration; and
using the plurality of fragments to convert the video data into a second format to be provided as an output, which is based on the video data that was received.

2. The method of claim 1, wherein the first format is associated with a Paint-On caption or a Roll-Up caption, and the second format is associated with a Pop-On caption.

3. The method of claim 1, wherein the first format is associated with subtitles.

4. The method of claim 1, wherein a sum of particular time durations of particular regions in a particular fragment of the text is equal to an entire time duration of the particular fragment.

5. The method of claim 1, further comprising:
evaluating timestamps associated with caption data; and
reordering the caption data to match an ordering of video frames for the output.

6. The method of claim 1, further comprising:
determining a level of space that a video processing module should reserve in a particular video frame associated with the video data.

7. The method of claim 1, further comprising:
providing a target bit rate based on an amount of caption data being processed at a packaging agent that converts the video data between the first format and the second format.

8. The method of claim 1, further comprising:
correcting errors in caption data that includes the text and control codes.

9. The method of claim 1, further comprising:
communicating information concerning frame ordering and frame timing for the video data.

10. Logic encoded in one or more non-transitory media that includes instructions for execution and when executed by a processor is operable to perform operations, comprising:
receiving video data from a video source in a first format, wherein the video data includes associated text to be overlaid on the video data as part of a video stream;
generating a plurality of fragments based on the text, wherein the fragments include respective regions having a designated time duration; and
using the plurality of fragments to convert the video data into a second format to be provided as an output, which is based on the video data that was received.

11. The logic of claim 10, the operations further comprising:
communicating a status for the particular device from the server in response to a request status update from a user interface.

12. The logic of claim 10, wherein the first format is associated with a Paint-On caption or a Roll-Up caption, and the second format is associated with a Pop-On caption.

13. The logic of claim 10, wherein the first format is associated with subtitles.

14. The logic of claim 10, wherein a sum of particular time durations of particular regions in a particular fragment of the text is equal to an entire time duration of the particular fragment.

15. The logic of claim 10, the operations further comprising:
evaluating timestamps associated with caption data; and
reordering the caption data to match an ordering of video frames for the output.

16. The logic of claim 10, the operations further comprising:
determining a level of space that a video processing module should reserve in a particular video frame associated with the video data.

17. The logic of claim 10, the operations further comprising:
providing a target bit rate based on an amount of caption data being processed at a packaging agent that converts the video data between the first format and the second format.

18. The logic of claim 10, the operations further comprising:
correcting errors in caption data that includes the text and control codes.

19. An apparatus, comprising:
a memory element configured to store instructions;
a processor coupled to the memory; and
a packaging agent, wherein the processor is operable to execute the instructions such that the apparatus is configured for:
receiving video data from a video source in a first format, wherein the video data includes associated text to be overlaid on the video data as part of a video stream;
generating a plurality of fragments based on the text, wherein the fragments include respective regions having a designated time duration; and
using the plurality of fragments to convert the video data into a second format to be provided as an output, which is based on the video data that was received.

20. The apparatus of claim 19, the apparatus being further configured for:
correcting errors in caption data that includes the text and control codes;
communicating information concerning frame ordering and frame timing for the video data; and
providing a target bit rate based on an amount of caption data being processed at the packaging agent that converts the video data between the first format and the second format.
